(19) United States
(12) Patent Application Publication
(10) Pub. No.: US 2003/0212181 A1
(43) Pub. Date: Nov. 13, 2003

(54) Autodepositing coating composition and process and coated metal articles therefrom

(76) Inventors: Takumi Honda, Tokyo (JP); Mayumi Yamamoto, Tokyo (JP); Ryosuke Sako, Tokyo (JP)

Correspondence Address: HENKEL CORPORATION, 2500 RENAISSANCE BLVD, STE 200, GULPH MILLS, PA, 19406, US

(21) Appl. No.: 10/168,205

(22) PCT Filed: Dec. 15, 2000
(86) PCT No.: PCT/US00/33996

(30) Foreign Application Priority Data
Dec. 17, 1999 (JP) 11/358257

(51) Int. Cl. C08K 3/00

(52) U.S. Cl. 524/438

(57) ABSTRACT

A water-based autodepositing coating composition that contains dissolved and/or dispersed anionic polyester resin comprising the condensate of (a) a polyhydric alcohol component and (b) an acid component in addition to acid, and metal ions and/or other oxidizing agents provides a coating composition that can impart an excellent corrosion resistance, adherence, and heat resistance to metal surfaces when applied to the metal surfaces and dried into place thereon, preferably with the use of heat. A rinse is usually preferably interposed between the application of the autodepositing composition and the drying operation.

### FIELD AND BACKGROUND OF THE INVENTION

This invention relates to a coating composition that provides metal surfaces with an excellent corrosion resistance, adherence, and heat resistance; to a process for coating metal surfaces; and to coated metals. More particularly, this invention relates to a water-based autodepositing coating composition—comprising water-dispersible or water-soluble organic resin, acid, and oxidizing agent and/or metal ions—that has the ability to provide metal surfaces with an excellent corrosion resistance, adherence, and heat resistance. The metal surfaces can be, for example, iron, galvanized, or aluminum surfaces, particularly ferriferous surfaces, and the desirable properties are imparted thereto by successive operations of forming an uncured organic resin coating on the metal surface by effecting contact between the metal surface and the aforesaid autodepositing coating composition, optionally rinsing the resulting coated metal surface with water, and drying the coated or rinsed coated metal surface, preferably with the application of heat. The invention also relates to a coating process and to coated metal articles of manufacture.

Water-based coating compositions that have the ability to form an organic resin coating on a metal surface by contact between the metal surface and an acidic coating composition containing organic resin are already known within the art of autodepositing coating compositions. Various examples thereof are taught in Japanese Published (Kokoku or Examined) Patent Application Number Sho 47-17630 (17,630/1972), Japanese Published (Kokoku or Examined) Patent Application Number Sho 52-21006 (21,006/1977), Japanese Published (Kokoku or Examined) Patent Application Number Sho 54-13435 (13,435/1979), and Japanese Laid Open (Kokai or Unexamined) Patent Application Number Sho 61-168673 (168,673/1986). A characteristic feature of these known coating compositions is their ability when a clean metal surface is immersed therein to form an organic resin coating whose thickness or weight increases with immersion time. In addition, since this coating formation is achieved by the chemical activity of the coating composition at the metal surface (metal ions eluted from the metal surface by etching acting on the resin particles to induce deposition thereof on the metal surface), this technology is distinguished from electrodeposition by its ability to efficiently form a resin coating on metal surfaces without the external application of electricity. Another advantage enjoyed by this technology is that it does not require a pretreatment such as phosphating and can therefore provide a shorter treatment sequence than, for example, electrodeposition coating processes.

However, the older autodepositing compositions were also unable to produce a satisfactory corrosion resistance or adherence for some conditions of service of the articles coated. This resulted in the development of a variety of tactics for improving the corrosion resistance and adherence of the organic resin coating formed on the metal surface.

For example, within the sphere of chemical treatment (post-treatment) of the still uncured organic resin coating, U.S. Pat. No. 3,795,546 teaches that the post-drying corrosion resistance of the organic resin coating can be improved by exposing the uncured organic resin coating, prior to its being thermally dried, to an aqueous solution that contains approximately 2.5 to 50 grams of polyacrylic acid per liter of composition, this unit of concentration being hereinafter usually abbreviated as “g/l”, and hexavalent chromium. The use of toxic hexavalent chromium in this treatment sequence, however, has several undesirable consequences: It raises the expense and effort that must be expended for wastewater treatment, and, since hexavalent chromium is present in the resulting organic resin coating, it raises environmental and safety issues.

Japanese Laid Open Patent Application (PCT) Number Hei 3-505841 (505,841/1991) teaches a coating treatment for metal surfaces in which the metal surface is treated with a vinylidene chloride resin-based aqueous coating composition and the corrosion resistance of the vinylidene chloride resin is then upgraded by exposing the uncured resin coating prior to its thermal drying to an alkaline aqueous solution.

This treatment does offer the advantage of not using toxic hexavalent chromium in the chemical treatment that produces an excellent corrosion resistance and adherence in the organic resin coating formed on the metal surface. However, the base component of the organic resin coating is vinylidene chloride resin, which has a poor heat resistance notwithstanding its excellent corrosion resistance. This poor heat resistance places limits on the applications of the coating; for example, it basically cannot be used in such thermally challenging environments as automotive engine compartments nor can it be used as a primer for top coats that are baked at high temperatures. Moreover, the above-described chemical treatment is essential for conferring adherence.

At present, then, no autodeposition process is known to the applicants to be available for coating metal surfaces to produce an excellent adherence, resistance to corrosion, and resistance to heat.

An object of this invention is to provide an autodepositing coating composition that can form a simultaneously highly heat-resistant, strongly adherent, and highly corrosion-resistant organic resin coating on metal surfaces (e.g., iron, zinc coating, and aluminum) and that can do so without requiring the use of a chemical treatment (post-treatment). Another object of this invention is to provide a process for coating metal surfaces to achieve these same purposes.

### BRIEF SUMMARY OF THE INVENTION

It has been found that the objects delineated above could be achieved by treatment of the metal surface with an autodepositing coating composition that comprises water-soluble or water-dispersible anionic polyester resin molecules that can be formed by condensing at least (a) a polyhydric alcohol component and (b) an acid component. (In the preceding sentence, “can be formed” means either that the polyester resin molecules actually were formed by condensing said components (a) and (b) or that the molecules have a chemical structure that could result from an actual condensation of a selected mixture that includes said components (a) and (b).) The invention also provides a process for coating metal surfaces by forming an uncured organic resin coating on the surface of a metal by contacting the metal surface with an autodepositing coating composition as described above, optionally rinsing the coated metal surface with water, and drying the coated metal surface, preferably with the application of heat. Finally, the invention provides articles of manufacture that comprise coated metal surfaces formed by such a process.

### DETAILED DESCRIPTION OF THE INVENTION AND PREFERRED EMBODIMENTS

In a mixture of monomers actually polymerized to make the molecules of any polyester resin used in this invention and in any hypothetical mixtures of such monomers inferred from analysis of the residues of monomers in any polyester resin used in this invention, at least, with increasing preference in the order given, 75, 80, 85, 90, or 95% of the molecules in the mixture are molecules of polyhydric alcohols or are molecules of acids that contain a total of at least two moieties that are carboxyl or carboxylate.

In an autodepositing coating composition according to this invention, at least part of the aforesaid polyhydric alcohol component (a) preferably is selected from the group consisting of:

(a.1) aliphatic polyhydric alcohols that conform to the immediately following general formula (1):

HO—R₁—OH,

in which R₁ represents a divalent organic moiety that:

contains from 1 to 10 carbon atoms;

may be either straight-chain or branched; and

is one of an unsubstituted alkylene moiety and a partially substituted alkylene moiety in which each substituent is either a hydroxyl moiety or a halo moiety; and

(a.2) aromatic polyhydric alcohols that conform to the immediately following general formula (2):

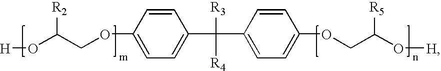

in which:

each of m and n independently is an integer with a value of at least one;

2≦(m+n)≦6; and

each of R₂, R₃, R₄, and R₅ is independently either hydrogen or methyl.

In the mixture of monomers actually polymerized to make the molecules of a polyester resin used in this invention and in any hypothetical mixtures of such monomers inferred from analysis of the residues of monomers in any polyester resin used in this invention, there preferably are polyhydric alcohols that conform to general formula (1) when the moiety represented by R₁ is “branched”, meaning that this moiety includes at least one carbon atom that is covalently bonded by single bonds to at least three, or more preferably to four, other carbon atoms. The single most preferred type of branched polyhydric alcohol is 2,2-dimethyl-1,3-propanediol (more commonly called neopentyl glycol).

Within the mixture of monomers actually polymerized to make the molecules of a polyester resin used in this invention and in any hypothetical mixtures of such monomers inferred from analysis of the residues of monomers in any polyester resin used in this invention, polyhydric alcohols that include a branched R₁ moiety in their molecules and conform to general formula (1) as described above preferably constitute a molar percentage of the total moles of polyhydric alcohols in the monomer mixture that is at least, with increasing preference in the order given, 1, 3, 5, or 9 and independently preferably is not more than, with increasing preference in the order given, 80, 75, 70, 65, 60, 55, or 51.

Independently, at least part of the aforesaid acid component (b) is preferably selected from the group consisting of:

(b.1) aliphatic compounds that conform to the immediately following general formula (3):

X₁OOC—R₆—COOX₂

in which:

each of X₁ and X₂ is independently selected from the group consisting of hydrogen and alkyl moieties that have not more than 10 carbon atoms in each alkyl moiety; and

R₆ represents a divalent organic moiety that:

may be straight-chain or branched;

has from 1 to 30 carbon atoms; and

is either an unsubstituted alkylene moiety or a partially substituted alkylene moiety in which each substituent conforms to the general formula —COOX₃, wherein X₃ is selected from the group consisting of hydrogen and alkyl moieties that have not more than 10 carbon atoms in each alkyl moiety;

(b.2) aromatic carboxylic acids and esters and salts thereof that conform to the immediately following general formula (4):

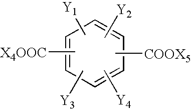

in which:

each of X₄ and X₅ is independently selected from the group consisting of hydrogen and alkyl moieties that have not more than 3 carbon atoms; and

each of Y₁, Y₂, Y₃, and Y₄ is independently selected from the group consisting of:

hydrogen;

moieties conforming to the general formula —COOX₆, wherein X₆ is selected from the group consisting of hydrogen, alkyl moieties having not more than three carbon atoms, Na, K, Ca, Ba, Li, and NH₄; and

moieties conforming to the general formula —SO₃Z₁, wherein Z₁ is selected from the group consisting of hydrogen, Na, K, ½Ca, ½Ba, Li, and NH₄;

(b.3) aromatic anhydrides that conform to the immediately following general formula (5)

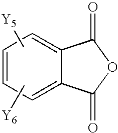

in which each of Y₅ and Y₆ is independently selected from the group consisting of:

hydrogen;

moieties conforming to the general formula —COOX₆; and

moieties conforming to the general formula —SO₃Z₁, each of X₆ and Z₁ having the same meaning as in part (b.2) above;

(b.4) the anhydride of pyromellitic acid, which has the immediately following chemical formula (6):

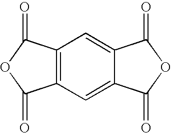

(b.5) naphthalene nucleus-containing compound according to the immediately following general formula (7):

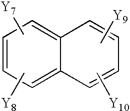

in which each of Y₇, Y₈, Y₉, and Y₁₀ is independently selected from the group consisting of hydrogen and moieties conforming to the general formula —COOX₈, X₈ being selected from the group consisting of hydrogen and alkyl moieties with not more than 3 carbon atoms; and

(b.6) compounds that would conform to general formula (4) except for having:

one additional ring substituent having the general formula —COOX₉, wherein X₉ is selected from the group consisting of hydrogen, alkyl moieties having not more than three carbon atoms, Na, K, Ca, Ba, Li, and NH₄; and

no Y₄ moiety.

Preferably, not more than, with increasing preference in the order given, 20, 15, 10, or 5 mole % of the monomer residues in the polyester resin used in a composition according to this invention for component (a) are monomers that are not part of either of the preferred groups of substances as defined in one of parts (a.1) and (a.2) as described above; and, independently, not more than, with increasing preference in the order given, 20, 15, 10, or 5 mole % of the monomer residues in the polyester resin used in a composition according to this invention for component (b) are monomers that are not part of any of the preferred groups of substances as defined in one of in parts (b.1) through (b.6) as described above. Independently, in any mixture of monomers actually polymerized to make the molecules of a polyester resin used in this invention and in any hypothetical mixtures of such monomers inferred from analysis of the residues of monomers in any polyester resin used in this invention, the molar ratio of hydroxyl moieties to the total of carboxyl and carboxylate moieties preferably is at least, with increasing preference in the order given, 0.50:1.00, 0.60:1.00, 0.70:1.00, 0.80:1.00, 0.90:1.00, 0.95:1.00, or 0.98:1.00 and independently preferably is not more than, with increasing preference in the order given, 1.50:1.00, 1.40.1.00, 1.30:100, 1.20:1.00, 1.15:1.00, 110:1.00, 1.08:1.00, 1.06:1.00, 1.04:1.00, or 1.02:1.00.

Suitable polyhydric alcohols of type (a.1) are specifically exemplified by ethylene glycol, neopentyl glycol, dibromoneopentyl glycol, 1,2-propanediol, 1,3-propanediol, 1,3-butanediol, 1,4-butanediol, 1,5-pentanediol, 1,6-hexanediol, 3-methylpentanediol, 1,4-cyclohexanedimethanol, 3-methyl-1,5-pentanediol, 2-methyl-1,3-propanediol, 2,2-dimethyl-1,3-propanediol, glycerol, pentaerythritol, trimethylolethane, and trimethylolpropane.

Suitable polyhydric alcohols of type (a.2) are specifically exemplified by the ethylene oxide adducts of bisphenol A, the propylene oxide adducts of bisphenol A, the ethylene oxide adducts of bisphenol F, and the propylene oxide adducts of bisphenol F.

If the use of any polyhydric alcohols that are not of either type (a.1) or type (a.2) is desired, diethylene glycol and/or dipropylene glycol are preferred.

The aliphatic carboxylic acids, salts, and esters that conform to general formula (3) are specifically exemplified by succinic acid, methylsuccinic acid, ethyl-succinic acid, butylsuccinic acid, the monomethyl ester of succinic acid, the dimethyl ester of succinic acid, the monoethyl ester of succinic acid, the diethyl ester of succinic acid, the monobutyl ester of succinic acid, the dibutyl ester of succinic acid, glutaric acid, methylglutaric acid, ethylglutaric acid, butylglutaric acid, the monomethyl ester of glutaric acid, the dimethyl ester of glutaric acid, the monoethyl ester of glutaric acid, the diethyl ester of glutaric acid, the monobutyl ester of glutaric acid, the dibutyl ester of glutaric acid, adipic acid, the monomethyl ester of adipic acid, the dimethyl ester of adipic acid, the monoethyl ester of adipic acid, the diethyl ester of adipic acid, the dioctyl ester of adipic acid, sebacic acid, the diethyl ester of sebacic acid, the dibutyl ester of sebacic ester, the dioctyl ester of sebacic acid, tricarballylic acid, and butanetetracarboxylic acid.

Aromatic carboxylic acids, salts, and esters that conform to general formula (4) are specifically exemplified by terephthalic acid, the monomethyl ester of terephthalic acid, the dimethyl ester of terephthalic acid, the monoethyl ester of terephthalic acid, the diethyl ester of terephthalic acid, isophthalic acid, the monomethyl ester of isophthalic acid, the dimethyl ester of isophthalic acid, 5-sulfoisophthalic acid, salts of 5-sulfoisophthalic acid (e.g., the Li, Na, and K salts), dimethyl 5-sulfoisophthalate, the salts of dimethyl 5-sulfoisophthalate (e.g., the Li, Na, K, Ca, Ba, and NH₄alts), trimellitic acid, the 1,4-dimethyl ester of trimellitic acid pyromellitic acid, the 1,4-dimethyl ester of pyromellitic acid, the tetramethyl ester of pyromellitic acid, and the tetraethyl ester of pyromellitic acid.

Compounds that conform to general formula (5) are specifically exemplified by phthalic anhydride, trimellitic anhydride, and the methyl ester of trimellitic anhydride.

Naphthalene-nucleus containing compounds that conform to general formula 7 are specifically exemplified by 1,2-naphthalenedicarboxylic acid, the dimethyl ester of 1,2-naphthalenedicarboxylic acid, 1,3-naphthalenedicarboxylic acid, the dimethyl ester of 1,3-naphthalenedicarboxylic acid, 1,4-naphthalenedicarboxylic acid, the dimethyl ester of 1,4-naphthalenedicarboxylic acid, 1,5-naphthalenedicarboxylic acid, the dimethyl ester of 1,5-naphthalenedicarboxylic acid, 1,6-naphthalenedicarboxylic acid, the dimethyl ester of 1,6-naphthalenedicarboxylic acid, 1,7-naphthalene-dicarboxylic acid, the dimethyl ester of 1,7-naphthalenedicarboxylic acid, 2,3-naphthalenedicarboxylic acid, the dimethyl ester of 2,3-naphthalenedicarboxylic acid, 2,6-naphthalenedicarboxylic acid, the dimethyl ester of 2,6-naphthalenedicarboxylic acid, 2,7-naphthalenedicarboxylic acid, and the dimethyl ester of 2,7-naphthalenedicarboxylic acid.

Based on considerations of corrosion resistance, adherence, and heat resistance, at least 60% of moles of the total acid component are selected from the group consisting of compounds conforming to general formula (4), general formula (5), and formula (6).

Still more preferably, not more than 40% of moles of the total acid component consists of selections from the group consisting of:

molecules conforming to general formula (4) when at least one of Y₁ through Y₄ in general formula (4) represents:

—COOX₆ and X₆ is selected from the group consisting of hydrogen, Na, K, Ca, Ba, Li, or NH₄; or

—SO₃Z₁ and Z₁ is selected from the group consisting of hydrogen, Na, K, Ca, Ba, Li, and NH₄); and

molecules conforming to general formula (5) when (b)-3 in which at least one of Y₅ and Y₆ in general formula (5) represents:

—COOX₇ and X₇ is selected from the group consisting of hydrogen, Na, K, Ca, Ba, Li, and NH₄; or

—SO₃Z₂ and Z₂ is selected from the group consisting of hydrogen, Na, K, Ca, Ba, Li, or NH₄.

A content in excess of 40 mole % selected from the group as defined immediately above in this paragraph results in a decline in corrosion resistance and adherence.

If the acid component contains any acids that are not part of preferred group (b) as described above, these acids are preferably selected from the group consisting of acid molecules that contain a non-aromatic C═C bond, or more preferably from the group consisting of maleic acid, maleic anhydride, fumaric acid, and itaconic acid.

The weight average molecular weight of the polyester resin used by this invention may range from 3,000 to 50,000.

The polyester resin used by this invention can be prepared by subjecting the above-described polyhydric alcohol component and acid component to an esterification (or transesterification) reaction at a temperature in the range from 140 to 300° C., optionally in the presence of a catalyst such as dibutyltin oxide, lead acetate, calcium acetate, or n-butyl titanate; cooling after optional removal of any excess alcohol component under reduced pressure (≦10 millimeters of mercury); melting the resulting condensate at 60 to 90° C. in the presence of water; and if necessary adding, for example, an amine or surfactant, in order to prepare a stable solution and/or dispersion of the condensate in water.

A polyester resin used in this invention preferably is anionic. In one embodiment, anionic surfactant can be added as the aforementioned surfactant in order to impart anionicity. Said anionic surfactant can be exemplified by alkylbenzenesulfonates, alkyl disulfates, alkyl diphenyl ether disulfonates, polyoxyethylene alkylphenyl ether sulfates, polyoxyethylene aryl ether sulfates, carboxylate surfactants, phosphate surfactants, naphthalenesulfonic acid/formaldehyde condensates, and polycarboxylate surfactants. The anionic surfactant should be added within a range that makes possible a stable dispersion of the polyhydric alcohol component/acid component condensate in water. Nonionic surfactant may be added on an optional basis within a range that does not impair the objects of the invention.

Suitable nonionic surfactants are exemplified by polyoxyethylene alkyl ethers wherein the alkyl is, for example, octyl, decyl, lauryl, stearyl, or oleyl; polyoxyethylene alkylphenyl ethers wherein the alkyl is, for example, octyl or nonyl; and polyoxyethylene-polyoxypropylene block polymers. Water-soluble resin containing sulfonic acid moieties and/or salts thereof, carboxyl moieties and/or salts thereof, and/or phosphoric acid moieties and/or salts thereof may also be added.

Sufficient anionicity for stability of the aqueous solution and/or dispersion of a polymer used in this invention can also be conferred by the presence in the acid component (b) of a sufficient fraction of one or more selections from:

preferred subgroup (b.2) in which at least one of Y₁ through Y₄ in general formula (4) is:

—COOX₆ and X₆ represents hydrogen, Na, K, Ca, Ba, Li, or NH₄; or

—SO₃Z₁ and Z₁ represents hydrogen, Na, K, Ca, Ba, Li, or NH₄; and

preferred subgroup (b.3) in which at least one of Y₅ and Y₆ in general formula (5) is:

—COOX₇ and X₇ represents hydrogen, Na, K, Ca, Ba, Li, or NH₄; or

—SO₃Z₂ and Z₂ represents hydrogen, Na, K, Ca, Ba, Li, or NH₄.

The autodepositing coating composition of this invention can be obtained by intermixing water-dispersible or water-soluble polyester resin obtained as described above with acid and oxidizing agent and optionally a compound that supplies metal ions and adding additional water as necessary. Said acid can be exemplified by at least one selection from fluorozirconic acid, fluorotitanic acid, fluorosilicic acid, fluoroboric acid, hydrofluoric acid, phosphoric acid, and nitric acid. Hydrofluoric acid is particularly preferred for the acid. Suitable as the oxidizing agent are, for example, potassium permanganate, hydrogen peroxide, and sodium nitrite, among which hydrogen peroxide is particularly preferred. The compound that can supply metal ions is not critical as long as it is stable in the coating composition. This metal ions source can be exemplified by ferric nitrate, ferric fluoride, ferrous phosphate, and cobaltous nitrate, with ferric fluoride being particularly preferred.

The content of the organic resin in the water-based coating composition used by this invention, expressed as the resin solids concentration, is preferably from to 550 g/l and more preferably is from 50 to 100 g/l. The acid concentration is preferably from 0.1 to 5.0 g/l and more preferably is from 0.5 to 3.0 g/l.

The concentration of the oxidizing agent is preferably from 0.01 to 3.0 g/l and more preferably is from 0.03 to 1.0 g/l. When a metal ions source is used, it is preferably used in a concentration not exceeding 50 g/l as the metal ions and more preferably is used at from 1.0 to 5.0 g/l as the metal ions.

The technique employed to coat metal surfaces with the water-based coating composition of this invention is not critical, but immersion is particularly preferred. The treatment temperature and the treatment time again are not critical, but suitable conditions in the case of immersion are immersion for 10 to 300 seconds and preferably 30 to 180 seconds in coating composition maintained within a temperature range from 15 to 30° C. and preferably from 20 to 25° C. Treatment outside these ranges is less likely to achieve the objects of this invention.

The coating weight of inventive coating composition on the metal surface is not critical, but the post-drying film thickness of the organic resin coating preferably is from 5 to 40 micrometres (this unit being hereinafter usually abbreviated as “μm”) and more preferably is from 10 to 25 μm. The desired coating performance often is not obtained at a film thickness below 5 μm, while films thicker than 40 μm are prone to blistering, which substantially impairs the quality of the appearance.

Coating treatment according to the present invention comprises a process in which: preferably, prior to application of the coating composition the metal surface is degreased and rinsed with water; necessarily, an uncured organic resin coating is formed on the metal surface using a coating composition including the polymer condensate of components (a) and (b) as described above; preferably, the coated metal surface is subsequently rinsed with water; and necessarily, the coating or rinsed coating is dried, preferably with the application of heat. While the drying temperature and time are not critical, the drying temperature preferably is from 80 to 200° C. and more preferably is from 100 to 180° C., and the drying time preferably is from 5 to 60 minutes and more preferably is from 10 to 30 minutes. Treatment outside these ranges is less likely to achieve the objects of this invention.

In order to improve the integrity of the organic resin coating formed on the metal surface, the coating composition of this invention may contain a coalescing agent, as known in the autodeposition art, in an amount that is not more than 10% by weight of the organic resin solids. This coalescing agent can be, for example, ethylene glycol monoethyl ether, ethylene glycol monobutyl ether, propylene glycol monomethyl ether, propylene glycol monopropyl ether, trimethylpentanediol isobutyrate, and 2-ethylhexyl diglycol. The use of more than 10% is undesirable due to a resulting decline in the stability of the coating composition. The coating composition optionally may also contain the above-described anionic surfactant and/or nonionic surfactant, with the goal of maintaining an even better coating composition stability. The coating composition optionally may also contain pigments, for example, carbon black, phthalocyanine blue, phthalocyanine green, and barium sulfate.

The water-based autodepositing coating composition used by this invention must contain anionic polyester resin as described above, but it may also contain—within a range that does not impair the objects of this invention—other water-dispersible or water-soluble organic resin(s) such as acrylic resin, urethane resin, epoxy resin, melamine resin, or phenolic resin.

Use of the water-based autodepositing coating composition according to the present invention to coat metal surfaces and particularly ferriferous metal surfaces functions to impart thereto an excellent corrosion resistance, adherence, and heat resistance and does so without any post-treatment (chemical treatment of the uncured resin film prior to drying).

This invention is illustrated in greater detail hereinbelow through working and comparative examples. The invention, however, is not limited to the working examples that follow.

Test Methods

The following methods were used to evaluate the properties of the coatings on the test panels fabricated in the working and comparative examples.

(1) Coating Thickness

The coating thickness was measured at three positions on the test panel (top, middle, bottom), and the average of the three measurement values is reported.

(2) Corrosion Resistance

A cross that reached the basis metal was scribed in the coating on the test panel. The test panel thus prepared was subjected to a 500-hour salt-spray test in accordance with Japanese Industrial Standard (“JIS”) Z-2371. Peeling with tape was carried out after salt-spray exposure, and the peel width (both sides, maximum, in millimeter(s)) from the cross cut was evaluated.

(3) Adherence (Crosshatch/Tape Peel Testing)

This test was run on the test panel both before and after its immersion for 240 hours in water at 40° C. In the test itself, a 100-mesh grid (1 millimeter×1 millimeter squares) was scribed into the test panel and peeled with tape, and the number of remaining coating squares was then counted. The pre-immersion and post-immersion scores are reported according to the following scale:

+++: no peeling

++: fewer than 10 squares peeled

+: at least 10 but fewer than 50 squares peeled

×: 50 or more squares peeled.

(4) Heat Resistance

The test panel was continuously heated for 24 hours at 150° C. and was then submitted to testing as in test (3) above. The test results were also scored as in (3).

Chemical Characteristics

The monomers used to make the polyester resins used by this invention are reported in Table 1. Amounts of 1.0 mole of total acid monomer(s) as shown in Table 1, 2.0 moles of total alcohol monomer(s) as shown in Table 1, and, as catalysts, 0.25 gram of calcium acetate and 0.10 gram of n-butyl titanate were introduced into a 1.0 liter size round bottom flask fitted with a Claisen adapter and an air-cooled condenser. The interior of the system was purged with nitrogen, followed by heating to 180° C. and melting of the contents. The temperature of the interior of the flask was then raised to 200° C., and the flask contents were stirred for approximately 2 hours while heating at this temperature. The temperature was subsequently raised to 260° C., after about 15 minutes the interior of the flask was evacuated to a pressure of 0.5 millimeters of mercury, and reaction was continued for approximately 3 hours. Then the reaction products were cooled under a nitrogen current and removed from the flask after cooling was complete.

The water-based resin emulsion was made by mixing the reaction products thus made with sufficient water to give a final solids content of 25% solids in the emulsion and sufficient aqueous ammonia to bring the final pH of the solution within the range from 6.0-7.0, all the components of this mixture being stirred together for 2 hours while heating to 100° C. in an autoclave.

The molecular weights of the polymers formed were measured by gel permeation chromatography, using a Shodex™ GPC KF-803 column with an inside diameter of 8 millimeters and a length of 300 millimeters, tetrahydrofuran as eluent, and polystyrene as the molecular weight standard. The resulting weight-average molecular weights are also shown in Table 1.

TABLE 1

| | | | Mole % of Monomers in Organic Resin | | | | | | | | |
|---|---|---|---|---|---|---|---|---|---|---|---|
| | | | Condensates for Use According to This | | | | | | | | |
| | | | Invention | | | | | | | | |
| Monomers in Condensates | | | A | B | C | D | E | F | G | H | I |
| Poly- | Type | Neopentyl glycol | 30 | 40 | 50 | 30 | 30 | | 23 | | 10 |
| hydric | (a.1) | Ethylene glycol | 70 | 60 | 50 | 65 | 70 | 100 | 72 | 70 | 90 |
| Alco- | | 1,4-Butanediol | | | | | | | | 30 | |
| hol | Type | Propylene oxide adduct | | | | | | | 5 | | |
| Mono- | (a.2) | of Bisphenol A | | | | | | | | | |
| mers | Other | Diethylene glycol | | | | 5 | | | | | |
| (a) | | | | | | | | | | | |
| Acid | Type | Sebacic acid | | | | | | | | 2 | |
| Mono- | (b.1) | | | | | | | | | | |
| mers | Type | Isophthalic acid | 40 | 41 | 35 | 48 | 40 | 40 | 41 | 28 | 45 |
| (b) | (b.2) | Terephthalic acid | | | 45 | | | | 41 | | |
| | | Dimethyl terephthalate | 40 | 41 | | 48 | 41 | 47 | | 28 | 45 |
| | | Sodium dimethyl 5-sulfo- | 4 | 2 | 4 | 2 | 1 | 8 | 2 | | 5 |
| | | isophthalate | | | | | | | | | |
| | | Trimellitic acid | 16 | 16 | 16 | | | | | | |
| | Type | Trimellitic anhydride | | | | | 18 | | 16 | 42 | |
| | (b.3) | | | | | | | | | | |
| | Type | Pyromellitic anhydride | | | | 2 | | | | | |
| | (b.4) | | | | | | | | | | |
| | Type | 2,6-Naphthalene-dicar- | | | | | | 5 | | | |
| | (b.5) | boxylic acid | | | | | | | | | |
| | Other | Malic anhydride | | | | | | | | | 5 |

| | | | | | | | | | |
|---|---|---|---|---|---|---|---|---|---|
| Molecular Weight of Resulting Polymer, | 4- | 4- | 4- | 10- | 7- | 3- | 9- | 10- | 4- |
| Thousands of Daltons | 5 | 5 | 5 | 12 | 8 | 4 | 10 | 12 | 5 |

### EXAMPLES 1 TO 9 ACCORDING TO THE INVENTION

Using polyester resins A through I with the compositions and molecular weights reported in Table 1, water-based coating compositions were prepared using the ingredients and proportions reported in Table 2, any material not otherwise specified being water. (In both Tables 1 and 2, a blank cell indicates that none of the substance in the row of the table at the left of the cell was used.) While holding the particular coating composition bath within a temperature range of 20 to 22° C., precleaned cold-rolled steel panels (70×150×0.8 millimeter(s)) were coated by immersion for 180 seconds. Coating was followed by a water rinse (immersion), and then drying for 20 minutes at 180° C. in a forced convection oven. The coating performance tests were run on the resulting panels.

TABLE 2

| | | g/l of Ingredient in Working Composition Number: | | | | | | | | |
|---|---|---|---|---|---|---|---|---|---|---|
| INGREDIENT | | 1 | 2 | 3 | 4 | 5 | 6 | 7 | 8 | 9 |
| Organic Resin as De- | A | 240 | | | | | | | | |
| scribed in Table 1 | B | | 240 | | | | | | | |
| | C | | | 240 | | | | | | |
| | D | | | | 240 | | | | | |
| | E | | | | | 240 | | | | |
| | F | | | | | | 240 | | | |
| | G | | | | | | | 240 | | |
| | H | | | | | | | | 240 | |
| | I | | | | | | | | | 220 |

| | | | | | | | | | |
|---|---|---|---|---|---|---|---|---|---|
| 2-Ethylhexyl diglycol* | | | | | | 3.0 | | | |
| Newcol ™ 707SN | | | | | 4.0 | | | 4.0 | |
| surfactant** | | | | | | | | | |
| Epirez ™ 3522W60*** | | | | | | | | | 8.3 |
| Hydrofluoric acid | 1.00 | 1.00 | 0.50 | 1.00 | 1.00 | 1.00 | 1.00 | 1.00 | 1.00 |
| Ferric Fluoride | 3.0 | 3.0 | 3.0 | 3.0 | 3.0 | 3.0 | 3.0 | 3.0 | 3.0 |
| Hydrogen peroxide | 0.10 | 0.10 | 0.10 | 0.10 | 0.10 | 0.10 | 0.10 | 0.10 | 0.10 |

NOTES FOR TABLE 2
*a coalescing agent, supplied by Nippon Nyukazai Co. Ltd.
**polyoxyethylene aryl ether sulfonate solution from Nippon Nyukazai Co., Ltd. with 30% non-volatiles content.
***nonionic epoxy resin solution/dispersion from Yuka Shell Epoxy Co., Ltd. with 30% non-volatiles content.

### COMPARATIVE EXAMPLES 1 AND 2

Water-based coating compositions were prepared that contained: for both comparative examples, 1.00 g/l of hydrofluoric acid, 3.0 g/l of ferric fluoride, and 0.10 g/l of hydrogen peroxide; for Comparative Example 1 only, 130 g/l of Rhoplex™ WL-91 acrylic resin from Rohm and Haas, which is reported by its supplier to contain 41.5% of non-volatile solids; and for Comparative Example 2 only, 109 g/l of Daran™ SL143 vinylidene chloride-type resin from W. R. Grace, which is reported by its supplier to contain 55% resin solids. These compositions were used under the same conditions as for Examples 1 to 9 to produce coated panels, except that for Comparative Example 2 only, the following process conditions were changed or added: immersion in the autodepositing composition was 150 seconds instead of 180 seconds; after water-rinsing, there was an added operation of immersion of the uncured organic resin coating for 1 minute in an aqueous solution of ammonium bicarbonate with a pH value of 8.0; and drying was at 110 instead of 180° C. The coating performance tests were run on the resulting panels.

The results of the evaluation testing performed in the working and comparative examples are reported in Table 3. These results demonstrate that the water-based autodepositing coating compositions of the invention (Examples 1 through 9) provided an excellent performance in all evaluations (corrosion resistance, adherence, and heat resistance) without the execution of a chemical treatment (post-treatment). Comparative Example 1, which employed an acrylic resin, gave a poor corrosion resistance. Comparative Example 2, which employed a vinylidene chloride-type resin, gave a poor heat resistance.

TABLE 3

| | | RESULT FROM TEST FOR: | | | | | | | | | | |
|---|---|---|---|---|---|---|---|---|---|---|---|---|
| | | Examples According to the Invention: | | | | | | | | | C. E.: | |
| TEST | | 1 | 2 | 3 | 4 | 5 | 6 | 7 | 8 | 9 | 1 | 2 |
| Coating Thickness, | | 20 | 18 | 18 | 15 | 17 | 15 | 18 | 20 | 20 | 20 | 15 |
| μm | | | | | | | | | | | | |
| Corrosion | | 6.0 | 5.0 | 5.5 | 6.0 | 8.0 | 9.0 | 8.0 | 12.0 | 12.0 | * | 5.0 |
| Resistance, μm | | | | | | | | | | | | |
| Adher- | Pre-im- | +++ | +++ | +++ | +++ | +++ | +++ | +++ | +++ | +++ | +++ | +++ |
| ence | mersion | | | | | | | | | | | |
| | Post-im- | +++ | +++ | +++ | +++ | +++ | +++ | +++ | +++ | +++ | +++ | +++ |
| | mersion | | | | | | | | | | | |
| Heat | Pre-im- | +++ | +++ | +++ | +++ | +++ | +++ | +++ | +++ | +++ | +++ | X |
| Resist- | mersion | | | | | | | | | | | |
| ance | Post-im- | +++ | +++ | +++ | +++ | +++ | +++ | +++ | +++ | +++ | +++ | X |
| | mersion | | | | | | | | | | | |

ABBREVIATION AND OTHER NOTES FOR TABLE 3
“C. E.” means “Comparative Examples”.
*This panel was rusted over its entire surface.

1. An autodepositing coating composition that comprises water and:
organic resin molecules dissolved, dispersed, or both dissolved and dispersed in said water;
dissolved acid; and
at least one of:
dissolved metal ions; and
dissolved oxidizing agent substances that are not metal ions,
wherein the improvement comprises including among said organic resin molecules of at least one anionic polyester resin that is a condensate of:
(a) a polyhydric alcohol component; and
(b) an acid component.

2. An autodepositing coating composition according to claim 1, in which:
at least 80 mole % of component (a) is selected from the group consisting of:
(a.1) aliphatic polyhydric alcohols that conform to the immediately following general formula (1):
HO—R₁—OH,
in which R₁ represents a divalent organic moiety that:
contains from 1 to 10 carbon atoms;
may be either straight-chain or branched; and
is one of an unsubstituted alkylene moiety and a partially substituted alkylene moiety in which each substituent is either a hydroxyl moiety or a halo moiety; and
(a.2) aromatic polyhydric alcohols that conform to the immediately following general formula (2): 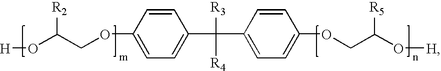
in which:
each of m and n independently is an integer with a value of at least one;
2≦(m+n)≦6; and
each of R₂, R₃, R₄, and R₅ is independently either hydrogen or methyl; and
at least 80 mole % of component (b) is selected from the group consisting of:
(b.1) aliphatic compounds that conform to the immediately following general formula (3):
X₁OOC—R₆—COOX₂
in which:
each of X₁ and X₂ is independently selected from the group consisting of hydrogen and alkyl moieties that have not more than 10 carbon atoms in each alkyl moiety; and
R₆ represents a divalent organic moiety that:
may be straight-chain or branched;
has from 1 to 30 carbon atoms; and
is either an unsubstituted alkylene moiety or a partially substituted alkylene moiety in which each substituent conforms to the general formula —COOX₃, wherein X₃ is selected from the group consisting of hydrogen and alkyl moieties that have not more than 10 carbon atoms in each alkyl moiety;
(b.2) aromatic carboxylic acids and esters and salts thereof that conform to the immediately following general formula (4): 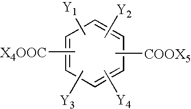
in which:
each of X₄ and X₅ is independently selected from the group consisting of hydrogen and alkyl moieties that have not more than 3 carbon atoms; and
each of Y₁, Y₂, Y₃, and Y₄ is independently selected from the group consisting of:
hydrogen;
moieties conforming to the general formula —COOX₆, wherein X₆ is selected from the group consisting of hydrogen, alkyl moieties having not more than three carbon atoms, Na, K, Ca, Ba, Li, and NH₄; and
moieties conforming to the general formula —SO₃Z₁, wherein Z₁ is selected from the group consisting of hydrogen, Na, K, ½Ca, ½Ba, Li, and NH₄;
(b.3) aromatic anhydrides that conform to the immediately following general formula (5) 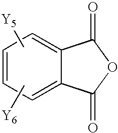
in which each of Y₅ and Y₆ is independently selected from the group consisting of:
hydrogen;
moieties conforming to the general formula —COOX₆; and
moieties conforming to the general formula —SO₃Z₁, each of X₆ and Z₁ having the same meaning as in part (b.2) above;
(b.4) the anhydride of pyromellitic acid, which has the immediately following chemical formula (6): 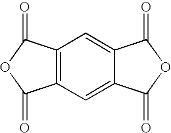
(b.5) naphthalene nucleus-containing compound according to the immediately following general formula (7): 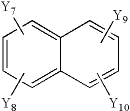
in which each of Y₇, Y₈, Y₉, and Y₁₀ is independently selected from the group consisting of hydrogen and moieties conforming to the general formula —COOX₈, X₈, wherein X₈ is selected from the group consisting of hydrogen and alkyl moieties with not more than 3 carbon atoms; and
(b.6) compounds that would conform to general formula (4) except for having:
one additional ring substituent having the general formula —COOX₉, wherein X₉ is selected from the group consisting of hydrogen, alkyl moieties having not more than three carbon atoms, Na, K, Ca, Ba, Li, and NH₄; and
no Y₄ moiety.

3. An autodepositing aqueous composition according to claim 2, in which:
at least 60% of moles of the total acid component (b) are selected from the group consisting of compounds conforming to general formula (4), general formula (5), and formula (6); and
not more than 40% of moles of the total acid component are selected from the group consisting of:
molecules conforming to general formula (4) when at least one of Y₁ through Y₄ in general formula (4) represents:
—COOX₆ and X₆ is selected from the group consisting of hydrogen, Na, K, Ca, Ba, Li, or NH₄; or
—SO₃Z₁ and Z₁ is selected from the group consisting of hydrogen, Na, K, Ca, Ba, Li, and NH₄; and
molecules conforming to general formula (5) when at least one of Y₅ and Y₆ in general formula (5) represents:
—COOX₇ and X₇ is selected from the group consisting of hydrogen, Na, K, Ca, Ba, Li, and NH₄; or
—SO₃Z₂ and Z₂ is selected from the group consisting of hydrogen, Na, K, Ca, Ba, Li, or NH₄.

4. An autodeposition aqueous liquid composition according to claim 3, wherein at least 5 mole % of component (a) consists of neo-pentyl glycol.

5. An autodeposition aqueous liquid composition according to claim 2, wherein at least 5 mole % of component (a) consists of neo-pentyl glycol.

6. An autodeposition aqueous liquid composition according to claim 1, wherein at least 5 mole % of component (a) consists of neo-pentyl glycol.

7. A process for coating a metal surface, said process comprising operations of:
(I) forming over said metal surface a wet coating of an autodepositing aqueous liquid composition according to any one of claims 1 through 6; and
(II) drying the coating formed in operation (I) as described above into place on the metal surface to form a dry coating that adheres to the metal surface.

8. A process according to claim 7, wherein:
there is an operation of rinsing with water included between operations (I) and (II); and
the drying of operation (II) is achieved at least in part by heating the metal surface to a temperature within a range from 80 to 200° C. for a time within a range from 5 to 60 minutes.

9. An article of manufacture comprising a surface coated by a process according to claim 8.

10. An article of manufacture comprising a surface coated by a process according to claim 7.
